(19) United States
(12) Patent Application Publication
(10) Pub. No.: US 2009/0271280 A1
(43) Pub. Date: Oct. 29, 2009

(54) RETAIL CUSTOMER SERVICE AND SYSTEM

(76) Inventor: Melissa Malone, New York, NY (US)

Correspondence Address: PATENT LAW OFFICES OF MICHAEL E. WOODS, 16 Hazel Ct., San Rafael, CA, 94901-5223, US

(21) Appl. No.: 12/110,527

(22) Filed: Apr. 28, 2008

(51) Int. Cl. G06Q 30/00

(52) U.S. Cl. 705/26

(57) ABSTRACT

A retail customer service process, method, system and apparatus that includes a bypass queue that is available to customers to enable them to place orders, pay for them, and to submit the bypassing order into a production queue as quickly as possible, preferably avoiding the first serial queue. The method includes an ordering queue including a plurality of customers coupled to a production control function, the production control function coupled to a production function for generating a production order from a particular one of the pluralities customer at a front of the ordering queue, the production order including a made-to-order product, and a production output queue in which customers wait for the made-to-order product to be produced from the production function as identified by the production order. The method provides a) coupling a bypass ordering queue to the production control function to insert a bypass production order into the production control function from a bypass customer not in the ordering queue; and b) receiving said bypass production order from said bypass customer by electronically reading a prestored bypass order from a portable indicia carried by said bypass customer.

### BACKGROUND OF THE INVENTION

The present invention relates generally to retail customer service, and more specifically to improvements in an onsite customer retail environment in which a customer typically enters a pair of serial queues; a first to place a production order for a custom product (including in some cases payment) and a second to receive the custom product by providing the customer with a bypass queue initiated electronically onsite.

There are retail environments in which a customer may identify a standard retail item or assemble a customized collection of standard retail items using a computer terminal. Many retailers include an online ordering system that includes an option for an in-store pickup of the order. Many of these systems permit a user to process an online order with a change to the delivery option. The user selects “IN-STORE PICKUP” which often saves delivery costs and time in the shipment process (when available). The process typically includes two emails—a first email acknowledging receipt of the order. When the selected store has the order ready, you receive a second email confirming that the order is ready for pickup. The credit card is typically charged at the time of the second email. The user takes varying authentication information to the store within a few days and picks up the order.

Of more relevance to the present invention, there are many retail environments in which a customer is required to wait in a first queue to order a product and sometimes to pay for it as well, and then wait in a second queue for the establishment to produce the ordered product. There can be long lines or wait times for both of these serial queues (serial queue referring to the customers being served in a generally first-in-first-out order, and needing to complete a progression through the first queue before entering the second queue). Some customers have insufficient time to wait in these queues, or are discouraged from ordering/waiting due to a perceived length of the double queues.

It is also common for retailers to include other items for sale or viewing that are offered to their customers. These customers may not always be able to peruse these offerings from their queues, so to the extent that the offerings are advantageous to the customer, the customer has a reduced exposure. This is not only detrimental to the customer, but also to the retailer who may be able to increase sales if the customer had sufficient opportunity to review and evaluate these offerings.

FIG. 1 is a diagram of a conventional retail system 100 well-known in the prior art. System 100 has a first queue 105 that interfaces to a production control function 110. System 100 has a second queue 115 that interfaces to a production function 120.

A customer enters first queue 105 and, after a wait time that varies based upon the position of the customer in first queue 105 and the speed by which the retailer services previous customers in the queue. After the wait time, the customer places an order for a customized product manufactured onsite by production function 120 in response to the customer order. The customer order is placed into production function 120 when production control function 110 has received/verified the customer order and any necessary payment made.

Once the customer order enters production function 120 from production control function 110, the customer enters into second queue 115. Again the customer waits in second queue 115 until the customer order is filled by production function 120.

Customers who frequent such a retailer often develop a limited number of favorite customized orders that they order all or a majority of time. It would be advantageous for the customer, and for the retailer, to make a bypass queue available to such customers to enable them to place orders, pay for them, and to get the order into a production queue as quickly as possible, preferably avoiding (i.e., “bypassing”) the first serial queue. The present invention addresses such a system, method, and apparatus.

### BRIEF SUMMARY OF THE INVENTION

Disclosed is a retail customer service process, method, system and apparatus that includes a bypass queue that is available to customers to enable them to place orders, pay for them, and to submit the bypassing order into a production queue as quickly as possible, preferably avoiding the first serial queue. The method includes an ordering queue including a plurality of customers coupled to a production control function, the production control function coupled to a production function for generating a production order from a particular one of the pluralities customer at a front of the ordering queue, the production order including a made-to-order product, and a production output queue in which customers wait for the made-to-order product to be produced from the production function as identified by the production order. The method provides a) coupling a bypass ordering queue to the production control function to insert a bypass production order into the production control function from a bypass customer not in the ordering queue; and b) receiving the bypass production order from the bypass customer by electronically reading a prestored bypass order from a portable indicia carried by the bypass customer.

A retail customer service system includes an ordering queue including a plurality of customers coupled to a production control function, the production control function coupled to a production function for generating a production order from a particular one of the pluralities customer at a front of the ordering queue, the production order including a made-to-order product, and a production output queue in which customers wait for the made-to-order product to be produced from the production function as identified by the production order. The system having a bypass ordering queue, coupled to the production control function, to insert a bypass production order into the production control function from a bypass customer not in the ordering queue; and an indicia ID reader for reading an indicia ID from a portable indicia carried by the bypass customer; and a database accessed using the indicia ID to produce the bypass production order for the bypass customer.

Benefits of embodiments of the present invention provides improvements in an onsite customer retail environment in which a customer typically enters a pair of serial queues; a first to place a production order for a custom product (including in some cases payment) and a second to receive the custom product by providing the customer with a bypass queue initiated electronically onsite. The bypass queue permits a customer to avoid time spent in the first serial queue, particularly important for frequent/repeat customers familiar with the retail/service options. The customer using the bypass queue may then have more time/incentive to peruse the secondary offerings in the establishment. the program.

Presence of Kiosks: The Worldwide growth of kiosks is projected to grow through 2009. The current installed based and thus familiarity in the US is particularly strong.

Benefits to the Customer:

1. Faster service

2. Customer feels important by being recognized by name.

3. Makes Retailer cool again and reaches the younger generation.

4. Allows the customer to have a closer relationship to Retailer.

5. No money exchanges hands.

6. The opportunity to win free drinks and prizes.

Benefits to Retailer:

1. Creation of a huge loyal database that can be mined later.

2. Potential for a float advantage on funds used in the system.

3. Provides a faster, more personalized service to its customers.

4. Can sell more merchandise as user waits.

5. Store can potentially be run with fewer staff.

6. Ability to capture potential lost sales from customers unwilling to wait in long lines.

7. Sets them apart from competitors.

### BRIEF DESCRIPTION OF THE DRAWINGS

FIG. 1 is a diagram of a conventional retail system well-known in the prior art;

FIG. 2 is a block diagram of a preferred embodiment of the present invention including a bypass queue; and

FIG. 3 is a block diagram of a preferred embodiment of the present invention including a database used in the bypass queue shown in FIG. 2.

### DETAILED DESCRIPTION OF THE INVENTION

The present invention relates to systems, methods, and computer program products that make a bypass queue available to onsite customers that enable them to place orders, pay for them, and to get the order into a production queue as quickly as possible, preferably by avoiding (i.e., “bypassing”) a first serial queue that receives and validates (e.g., receives payment) a desired customer order. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

The following description, and claims, uses the term “ID” and related words in their expansive sense to include any electronic data that may serve as an absolute unique mapping to a particular “user” or a relative unique mapping that is unique within the subject reference pool. For example, account numbers, telephone numbers, email addresses, and the like may all be an ID for understanding the embodiments and the present invention.

By customer, the following description not only includes a person, user, or the like operating or using the system\method, but includes processes and daemons and other automated/autonomous entities that may or may not be controlled (directly or indirectly) by a human.

One preferred context for the present invention is a physical retail store (e.g., a coffee shop offering customers a wide-range of customizable beverages and related products) that services a group of users (e.g., tens or hundreds of people each day) each having some unique electronic identification (a user name, email address, handle, avatar, or the like that is an ID) by which the retail store may reference any particular customer. The customers each have an ability to wait in a first queue to place an order for a customized beverage of their choice (and to pay for the beverage) and then wait in a second queue while the beverage is produced onsite. The embodiments of the present invention include a bypass queue to bypass the first queue, preferably automatically by using the ID, to insert a bypass order into the production function for the customer, without the customer waiting in the first queue.

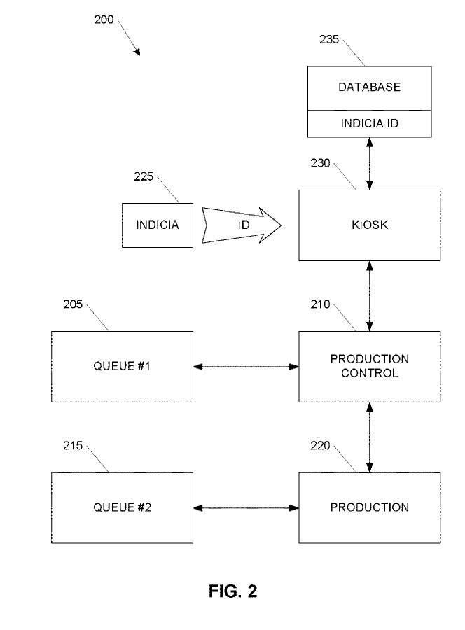

FIG. 2 is a block diagram of a preferred embodiment of the present invention for a retail system 200. System 200 has a first queue 205 that interfaces to a production control function 210. System 200 has a second queue 215 that interfaces to a production function 220. First queue 205 is bypassable as further described herein.

System 200 includes one or more bypass queues that each includes an indicia 225 having an ID that interfaces to a bypass station (e.g., a kiosk) 230. Bypass station 230 may include a database 235 keyed by the ID to retrieve one or more prestored customized bypass orders. Bypass station 230 includes an interface to production control function 210 (or in some cases directly to production function 220) and permits a particular selected one bypass order to enter into production function 220.

In a preferred embodiment, the ID from indicia 225 is stored in a machine-readable format. Indicia 225 is portable and carried by the user, and may include a “credit card” type device having a magnetic stripe or a “quick pass” token or transponder device, such as integrated into a key fob or other small portable device that may be placed on a keychain, or into a purse or pocket, that permits the customer to simply enter the ID into bypass station 230. In some embodiments, the customer may receive an ID/PIN that the user may directly type or otherwise enter into bypass station 230.

Due to the varying ages and preferences of consumers, the customized retailer card (indicia) should have the ability to either tie payment to a credit card or via cash added to the card. Some consumers will walk to the store and others will drive, the card preferably will be in the form of both a key chain fob and a card that can easily fit in a wallet. The card should also be able to be used as either a gift card or an extension to a credit card at register. For example, when the customer doesn't want to purchase their favorite drink during a store visit, they should be able to place their order at register and use their fob/card to pay. Customers should also be given the option to activate their card online or via the phone. It is advantageous to have an in-store rep at the launch of the card to help answer any questions and help activate cards online. Customers under 18 must have an adult/parent activate the card. The risk of loss should be minimized by being able to deactivate a card via the phone/internet.

Bypass station 230 preferably uses the ID to access database 235 to receive one or more prestored bypass orders. These prestored orders have been previously established by a bypass customer associated with indicia 225, as further described herein. When the bypass customer has established multiple prestored bypass orders, bypass station 230 reads those orders from database 235 and presents them to the bypass customer. The bypass customer selects a particular one of the prestored bypass orders and the selected bypass order becomes the bypassed customer order entered into production function 220. In the preferred embodiment, the selected bypass order enters production function 220 through production control function 210 so a payment account associated with the ID is used to authorize the production of the bypassed customer order.

Variations include storage of the prestored bypass orders on indicia 225 with bypass station 230 able to read the orders and the ID from indicia 225 in lieu of, or in addition to, orders from database 235. In some embodiments, database 235 and/or indicia 225 store a single prestored bypass order. In such cases, system 200 may not present the bypass order for selection but may directly and automatically enter, validate, and authorize submission of the order into production function 220. In some variations, the bypass customer may be able to further modify one of the prestored bypass orders prior to selection and entry into production.

Database 235 may also store additional metrics and customer data, demographic, and usage information. For example the bypass customer may be identified by their name when the production function completes production of the bypass order. Database 235 may provide the name of the customer along with the bypass order when accessing the production function to personalize the order and ease delivery. Other mechanisms may be used to associate each bypass customer with their produced bypass order.

In operation, a customer enters a bypassable first queue 205 and, after a wait time that varies based upon the position of the customer in first queue 205 and the speed by which the retailer services previous customers in the queue. After the wait time, the customer places an order for a customized product manufactured onsite by production function 220 in response to the customer order. The customer order is placed into production function 220 when production control function 210 has received/verified the customer order and any necessary payment made.

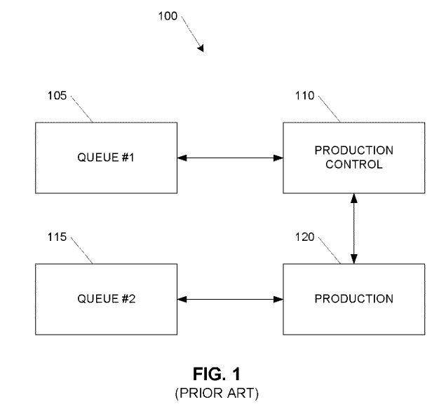

Once the customer order enters production function 220 from production control function 210, the customer enters into second queue 215. Again the customer waits in second queue 215 until the customer order is filled by production function 220. This operation is similar to the system described in FIG. 1, except for the experience of a bypass customer. As described herein, the bypass customer includes indicia 225 that permits a user to select a bypass order at a bypass station without entering into, or waiting within, bypassable first queue 205. The selected bypass order is automatically entered into production function 220, and may include a name or other preselected reference that is used to match the bypass customer to their produced bypass order.

The bypass customer saves the time difference between traversing the bypass queue and bypassing the first queue. The saved time may be used for the benefit of both the bypass customer and the retailer. Additionally, the experience of non-bypass customers is also enhanced as the depth of the first queue will be shorter the more that bypass customers make use of the bypass system. In some instances, the production function may be largely automated, and thus the capacity of the retailer may be increased by providing multiple parallel inputs (e.g., production control 210 and each of the bypass queues) into production function 220.

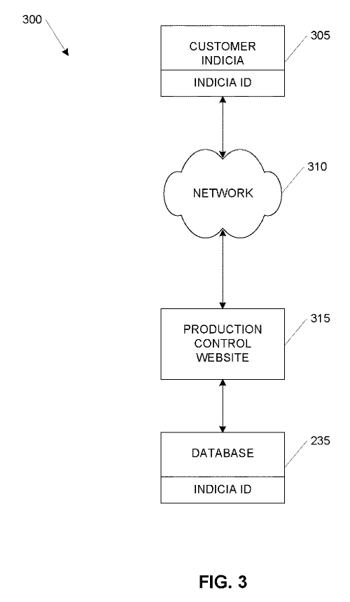

FIG. 3 is a block diagram of a preferred embodiment of a bypass order creation system 300 for creating/managing database 235 used in the bypass queue shown in FIG. 2. System 300 includes a unique customer reference 305 that is coupled to a computing system (e.g., a personal computer) for account creation. Reference 305 is coupled through a network 310 to a production control website 315, with the website including the options, permitted substitutions, and possible variations for bypass orders. A prospective potential bypass customer uses the production control website to create the one or more prestored bypass orders referenced above. Production control website 315 is coupled to database 235 to store and associate the created one or more prestored bypass orders with the indicia ID of reference 305. Thereafter, system 200 shown in FIG. 2 uses the information in database 235 as described herein.

In some systems, system 300 provides for the production control website to write the one or more prestored bypass order onto the indicia or reference 305. In other systems, bypass station 230 shown in FIG. 2 may be used as a system to both read the ID from indicia 225 and to create/write the prestored bypass orders.

Example Customer Experience Process Description

1. User obtains a free identity card from Starbucks with a barcode or chip inside the card that is unique to that person.

2. User goes online and logs into the Starbucks website to set up an account based on the card number. User will be asked to give full contact info and a unique personal identifier. This protects the user in case a card is lost or stolen it cannot be used by another party without the personal user identifier.

3. After completing the contact information and personal identifier. User will automatically be entered into monthly drawing for trips and free beverages prizes or discounts.

4. User picks out his favorite drinks or creates his own online and this is entered into his Starbucks personality profile.

5. User then enters store and scans or swipes his card via a kiosk with screen that identifies who he is by name. Computer speaks. “Hello Jack, Welcome back. What can we serve you today?” The user sees his Starbucks profile and chooses his drink order from his profile. By confirming the order, the user's credit card or available cash on the card is billed. Order is then sent wirelessly to the serving station where it comes up on a screen and it is made to order. While waiting for his order a user can look around the store at any new merchandise that has come in. When the beverage is ready the Barista simply says “Jack your drink is ready” versus calling out “one non-fat frappuccino grande.”

All or part of the system, method, and computer program product described in this application may, of course, be embodied in hardware; e.g., within or coupled to a Central Processing Unit (“CPU”), microprocessor, microcontroller, System on Chip (“SOC”), or any other programmable device. Additionally, the system, method, and computer program product may be embodied in software (e.g., computer readable code, program code, instructions and/or data disposed in any form, such as source, object or machine language) disposed, for example, in a computer usable (e.g., readable) medium configured to store the software. Such software enables the function, fabrication, modeling, simulation, description and/or testing of the apparatus and processes described herein. For example, this can be accomplished through the use of general programming languages (e.g., C, C++), GDSII databases, hardware description languages (HDL) including Verilog HDL, VHDL, AHDL (Altera HDL) and so on, or other available programs, databases, nanoprocessing, and/or circuit (i.e., schematic) capture tools. Such software may be disposed in any known computer usable medium including semiconductor, magnetic disk, optical disc (e.g., CD-ROM, DVD-ROM, etc.) and as a computer data signal embodied in a computer usable (e.g., readable) transmission medium (e.g., carrier wave or any other medium including digital, optical, or analog-based medium). As such, the software can be transmitted over communication networks including the Internet and intranets. A system, method, and computer program product embodied in software may be included in a semiconductor intellectual property core (e.g., embodied in HDL) and transformed to hardware in the production of integrated circuits. Additionally, a system, method, and computer program product as described herein may be embodied as a combination of hardware and software.

One of the preferred implementations of the present invention is as a routine in an operating system made up of programming steps or instructions resident in a memory of a computing system as well known, during computer operations. Until required by the computer system, the program instructions may be stored in another readable medium, e.g. in a disk drive, or in a removable memory, such as an optical disk for use in a CD ROM computer input or in a floppy disk for use in a floppy disk drive computer input. Further, the program instructions may be stored in the memory of another computer prior to use in the system of the present invention and transmitted over a LAN or a WAN, such as the Internet, when required by the user of the present invention. One skilled in the art should appreciate that the processes controlling the present invention are capable of being distributed in the form of computer readable media in a variety of forms.

Any suitable programming language can be used to implement the routines of the present invention including C, C++, Java, assembly language, and the like. Different programming techniques may be employed such as procedural or object oriented. The routines can execute on a single processing device or multiple processors. Although the steps, operations or computations may be presented in a specific order, this order may be changed in different embodiments. In some embodiments, multiple steps shown as sequential in this specification can be performed at the same time. The sequence of operations described herein can be interrupted, suspended, or otherwise controlled by another process, such as an operating system, kernel, and the like. The routines can operate in an operating system environment or as stand-alone routines occupying all, or a substantial part, of the system processing.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “computer-readable medium” for purposes of embodiments of the present invention may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of the present invention can be achieved by any means as is known in the art. Distributed, or networked systems, components and circuits can be used. Communication, or transfer, of data may be wired, wireless, or by any other mechanism.

It will also be appreciated that one or more of the elements depicted in the drawings/figures may also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims. Thus, the scope of the invention is to be determined solely by the appended claims.

What is claimed as new and desired to be protected by Letters Patent of the United States is:

1. A retail customer service process including an ordering queue including a plurality of customers coupled to a production control function, the production control function coupled to a production function for generating a production order from a particular one of the pluralities customer at a front of the ordering queue, the production order including a made-to-order product, and a production output queue in which customers wait for the made-to-order product to be produced from the production function as identified by the production order, the method comprising:
a) coupling a bypass ordering queue to the production control function to insert a bypass production order into the production control function from a bypass customer not in the ordering queue; and
b) receiving said bypass production order from said bypass customer by electronically reading a prestored bypass order from a portable indicia carried by said bypass customer.

2. The retail customer service process of claim 1 wherein said indicia is an electronically readable card.

3. A retail customer service process including an ordering queue including a plurality of customers coupled to a production control function, the production control function coupled to a production function for generating a production order from a particular one of the pluralities customer at a front of the ordering queue, the production order including a made-to-order product, and a production output queue in which customers wait for the made-to-order product to be produced from the production function as identified by the production order, the method comprising:
a) coupling a bypass ordering queue to the production control function to insert a bypass production order into the production control function from a bypass customer not in the ordering queue;
b) reading electronically an indicia ID from a portable indicia carried by said bypass customer; and
c) accessing a database using said indicia ID to produce said bypass production order for said bypass customer.

4. The retail customer service process of claim 3 wherein said indicia is an electronically readable card.

5. The retail customer service process of claim 4 wherein said bypass production order is written into said database using an electronic device offsite from the production function.

6. The retail customer service process of claim 5 wherein said electronic device is a personal computer accessing said database over a network.

7. The retail customer service process of claim 3 wherein said bypass production order includes a purchase price and wherein said indicia ID includes a payment reference for satisfying said purchase price.

8. The retail customer service process of claim 7 wherein said payment reference is included in said database accessed by said indicia ID.

9. The retail customer service process of claim 7 wherein said payment reference is included on said portable indicia.

10. The retail customer service process of claim 3 wherein said database includes a plurality of customized production orders associated with said indicia ID and wherein said bypass customer selects at least one of said plurality of customized production orders as said bypass production order.

11. A retail customer service system including an ordering queue including a plurality of customers coupled to a production control function, the production control function coupled to a production function for generating a production order from a particular one of the pluralities customer at a front of the ordering queue, the production order including a made-to-order product, and a production output queue in which customers wait for the made-to-order product to be produced from the production function as identified by the production order, comprising:
a bypass ordering queue, coupled to the production control function, to insert a bypass production order into the production control function from a bypass customer not in the ordering queue; and
an indicia ID reader for reading an indicia ID from a portable indicia carried by said bypass customer; and
a database accessed using said indicia ID to produce said bypass production order for said bypass customer.
